(19) United States
(12) Patent Application Publication
(10) Pub. No.: US 2025/0243096 A1
(43) Pub. Date: Jul. 31, 2025

(54) Microfluidic Synthesis and Crystallization of Pollutants

(71) Applicant: Kenneth Mitchell, JR., Chamblee, GA (US)

(72) Inventor: Kenneth Mitchell, JR., Chamblee, GA (US)

(21) Appl. No.: 18/424,775

(22) Filed: Jan. 27, 2024

(51) Int. Cl. C02F 9/00; C02F 1/00; C02F 1/48; C02F 1/52; C02F 1/72; C02F 3/34

(52) U.S. Cl. CPC C02F 9/00; C02F 1/008; C02F 1/48; C02F 2001/5218; C02F 1/725; C02F 3/342; C02F 2201/007; C02F 2209/02; C02F 2209/40

(57) ABSTRACT

An advanced water filtration system is provided, utilizing a novel combination of microfluidic channels, integrated catalytic materials, and electrocoalescence facilitated by strategically placed electrodes, alongside the incorporation of time crystals. This system addresses the limitations of traditional filtration methods by introducing precise control over fluid dynamics and contaminant interaction at a microscale. The microfluidic channels are designed to maximize fluid-catalyst contact, enhancing the efficiency of impurity removal, while the electrodes apply adjustable electric fields for effective separation of contaminants. The use of time crystals allows for a unique manipulation of particle dynamics, contributing to the system's high specificity and adaptability to various purification scenarios. This invention signifies a leap in water filtration technology, offering a sophisticated solution capable of addressing the complexities of purifying fluids in environments such as oil and gas extraction, and is adaptable to different purification needs and challenges in fluid dynamics.

### BACKGROUND

The present invention relates generally to the field of water filtration systems. More specifically, it pertains to an advanced water filtration system utilizing microfluidic channels, catalytic materials, electrocoalescence, and the integration of time crystals for enhanced fluid purification.

Traditional water filtration systems often rely on physical barriers such as membranes or filters to separate impurities from fluids. While effective to a degree, these systems can lack specificity and efficiency, particularly when dealing with complex emulsions or a wide range of contaminants. Recent advancements in microfluidics and nanotechnology have led to the development of more advanced systems capable of addressing these shortcomings.

For instance, a continuous flow microfluidic system for the manufacture of nanoparticles demonstrates the potential of microfluidics in handling complex fluid dynamics with high precision and scalability (U.S. patent application No. 20210113974). This system exemplifies the advancement in microfluidic technology, offering insights into the control and manipulation of fluid flow at a microscale, which is central to the present invention.

Additionally, the integration of electrodes into microfluidic systems for electrostatic field applications has been a focus of recent research. A notable advancement in this area is the use of silicon as a base material for microfluidic channels, combined with a bonded glass wafer, to improve long-term stability and performance in electrostatic applications (Direct electrification of silicon microfluidics, Microsystems & Nanoengineering). This development is particularly relevant to the present invention, which utilizes electrocoalescence as a key component of its water filtration system.

Moreover, the field of nanocatalysis has seen significant developments, particularly in integrating catalytic materials with microfluidic devices. These advancements are crucial to the present invention, which incorporates catalytic materials within microfluidic channels to enhance fluid purification. The integration of nanocatalysis in microfluidic devices offers a pathway to more efficient and specific contaminant removal, a core aspect of the present invention.

### SUMMARY

The present invention addresses the limitations of traditional water filtration systems by introducing a novel approach that combines microfluidic channel design, catalytic materials, electrocoalescence, and the integration of time crystals. This combination results in a system that is highly efficient, precise, and customizable for various purification needs, particularly in challenging environments such as oil and gas extraction.

According to one aspect of the present invention, there is provided an advanced water filtration system comprising: a network of microfluidic channels for precise fluid manipulation; catalytic materials integrated within these channels for enhanced purification; an electrocoalescence mechanism utilizing strategically positioned electrodes to generate controllable electric fields; an advanced control system for managing these electric fields; and the integration of time crystal elements to optimize fluid interaction and contaminant removal.

This invention revolutionizes the process of separating immiscible fluids through its innovative use of electrocoalescence. By strategically positioning electrodes within the microfluidic channels, the system applies localized electric fields across emulsions, significantly accelerating the coalescence of immiscible fluids like oil and water. This method not only expedites the separation process but also enhances the overall efficiency and effectiveness of fluid purification. Moreover, the integration of time crystals in the system represents a groundbreaking approach to fluid dynamics control. These time crystals influence the formation of structured clathrate-like assemblies, enabling the selective encapsulation and removal of specific contaminants. This unique feature, coupled with the precision offered by microfluidic technology, allows for unparalleled control over the purification process, ensuring that the system can adapt to a wide range of fluid compositions and contamination scenarios. The synergy between the catalytic materials, electrocoalescence, and time crystal integration leads to a filtration system that is not only more efficient but also more versatile, addressing the complex challenges of modern fluid purification in industries such as oil and gas extraction, petrochemical processing, and environmental remediation.

In summary, the present invention represents a significant advancement in the field of water filtration, offering a solution that is both innovative and highly effective in addressing the complexities of fluid purification in the modern world. The integration of cutting-edge technologies in microfluidics, catalysis, and electrocoalescence sets this invention apart from existing systems, providing a more comprehensive and efficient approach to water purification.

### BRIEF DESCRIPTION OF THE DRAWINGS

FIG. 1 illustrates the detailed design of the microfluidic channels, highlighting their geometry.

FIG. 2 details the implementation and operational aspects of the water filtration system.

### DETAILED DESCRIPTION

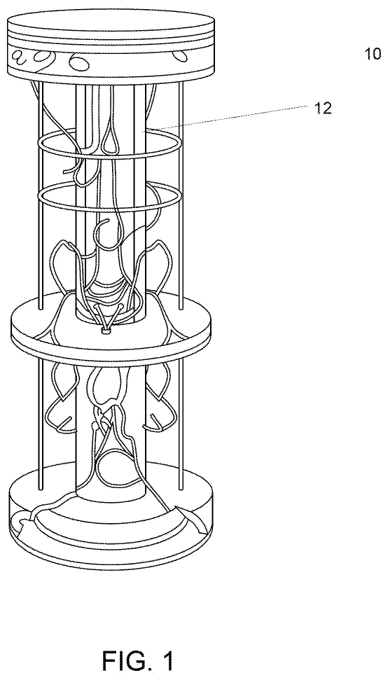

### FIG. 1: Microfluidic Channel Design

FIG. 1 delves into the microfluidic channel design within the water filtration system, emphasizing the importance of fluid-catalyst interaction for efficient purification. The channel 10 is intricately designed to optimize fluid dynamics and enhance the efficiency of contaminant removal. The geometry and dimensions of the channel are adaptable, allowing the system to handle different fluid types and contaminants effectively. Catalytic materials and lithographically integrated time crystals 12 are embedded within these channels, positioned to maximize interaction with the fluid and ensure thorough purification.

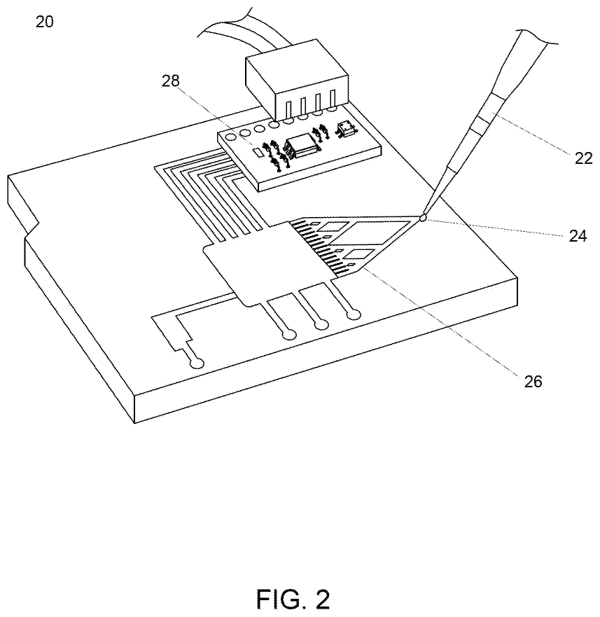

### FIG. 2: Implementation and Operation of the Water Filtration System

FIG. 2 details the implementation and operational aspects of the water filtration system 20. This figure illustrates the sequence of processes and mechanisms that enable efficient fluid purification.

Contaminated fluid 22 enters the system through an inlet 24 and is directed through the microfluidic channels 26 wherein multiple purification methods are implemented. These methods comprise: the implementation of catalytic materials wherein the fluid interacts with catalytic materials embedded within the channels, facilitating reactions that break down or transform contaminants; electrocoalescence wherein, electrodes are adjusted and optimized for the contaminant of choice to create an electric field, impacting the movement and coalescence of charged particles causing clathrate formation; time crystals to introduce temporal regularities synchronizing the movement of particles to assist electrocoalescencent clathrate formation; viscous energy based channel design wherein the design of the channels considers the fluid's viscosity and the energy dissipated during the flow, optimizing the system's energy efficiency by leveraging viscous dissipation energy to enhance the purification process, reducing the overall energy consumption.

Once purified, the fluid exits the system through an outlet ready for use or further processing. Integrated sensors 28 monitor the purification process, providing real-time data on fluid quality and system performance. The system's operational parameters, such as flow rate and electric field strength, can be adjusted based on this data to optimize purification efficiency. The system's modular design allows for customization based on specific purification needs, including the choice of catalytic materials and the configuration of microfluidic channels and electrodes.

The embodiments described are illustrative of the invention's scope. Elements, arrangements, materials, and sizes can vary as needed. Moreover, constituents of these embodiments may be interchangeable, demonstrating the invention's adaptability to different purification needs and fluid dynamics challenges.

What is claimed is:

1. A Water Filtration System, comprising:
a plurality of microfluidic channels; catalytic materials integrated within said microfluidic channels; a time crystal assisted electrocoalescence mechanism involving electrodes positioned within said microfluidic channels; and a control system for managing features comprising electric field strength, flow rate and temperature.

2. The system of claim 1, wherein said microfluidic channels are constructed from materials comprising: polydimethylsiloxane (PDMS), glass, silicon, and polymethylmethacrylate (PMMA).

3. The system of claim 1, wherein said catalytic materials comprise nanoparticles selected from the group consisting of metal nanoparticles, metal oxides, and enzymes.

4. The system of claim 1, further comprising a system for immobilizing said catalytic materials onto surfaces of said microfluidic channels.

5. The system of claim 1, wherein said electrocoalescence mechanism is capable of generating an electric field with adjustable strength and configuration.

6. The system of claim 1, wherein said time crystals are utilized for controlling particle dynamics.

7. A Method for Water Filtration, utilizing The system of claim 1, comprising: passing a fluid through said microfluidic channels; interacting said fluid with said catalytic materials for purification; applying an electric field to said fluid for electrocoalescence; utilizing said time crystals for enhanced clathrate formation, contaminant encapsulation, and enablement of selective separation of fluid components;

8. The method of claim 7, wherein said fluid interaction with catalytic materials includes oxidation-reduction reactions, biochemical degradation, or adsorption and transformation of contaminants.

9. The system of claim 1, wherein said microfluidic channels are designed to maximize surface area-to-volume ratio for enhanced contact between the fluid and catalytic surfaces.

10. The system of claim 1, further comprising a sensing mechanism integrated within said microfluidic channels for real-time monitoring of purification processes.

11. The system of claim 1, wherein said time crystals are used for enhancing clathrate formation within the microfluidic channels, thereby facilitating the encapsulation and removal of specific contaminants.

12. The system of claim 1, wherein the combination of catalytic materials and electrocoalescence is optimized using multiphysics simulation tools for enhanced purification efficiency.

13. The system of claim 1, further comprising a modular design allowing for customization of microfluidic channel geometry, catalytic material selection, and electric field configurations for specific fluid compositions.

14. The system of claim 1, wherein the microfluidic channels are designed with specific geometries and dimensions to optimize fluid flow dynamics and enhance interaction with the catalytic materials.

15. The system of claim 1, further comprising a system for varying the electric field strength and configuration within the microfluidic channels to adapt to different fluid compositions and contaminant types.

16. The system of claim 1, wherein the catalytic materials are selected and arranged within the channels to target specific contaminants, allowing for customization of the purification process.

17. The method of claim 7, wherein the operator can adjust the flow rate and operating conditions within the microfluidic channels to enhance the effectiveness of the method.

18. The system of claim 1, further comprising additional functionalities, such as real-time monitoring sensors, supplementary purification modules, and machine learning analysis integrated within the system to enhance overall performance and adaptability.
